(19) United States
(12) Patent Application Publication
(10) Pub. No.: US 2008/0268155 A1
(43) Pub. Date: Oct. 30, 2008

(54) Easy texture

(76) Inventor: Mohiuddin Ahmed Chowdhury, Irvine, CA (US)

Correspondence Address: MOHIUDDIN AHMED CHOWDHURY, 25 MOUNT VERNON, IRVINE, CA, 92620, US

(21) Appl. No.: 11/796,180

(22) Filed: Apr. 27, 2007

(51) Int. Cl. B05D 5/02

(52) U.S. Cl. 427/257; 425/472

(57) ABSTRACT

A mat with a textured surface capable of creating a corresponding texture on soft coating of joint compound on drywall surface by being pressed lightly on the compound, thus rendering the drywall textured.

### BACKGROUND OF THE INVENTION

This invention is a device useful for applying texture on drywall. It has a surface which is pressed onto drywall surface that is freshly coated with a joint compound. The pressure molds the joint compound which upon drying leaves a permanent texture on the drywall.

1. Discussion of Prior Art

Since the 1920s houses have commonly employed drywalls for making interior walls and ceilings. Generally these gypsum panels are attached to wooden studs with screws or nails. The screw or nail heads as well as the seams between the panels and any cracks or imperfections are completely covered with specific paste materials called joint compound etc. The paste dries to a hard surface which is usually sanded smooth. Commonly a textured surface is preferred to the smooth surface. Therefore a texture is applied before painting the wall or the ceiling.

A new house or a new room involves a large area of drywall and the practical method of applying the texture is by mechanically shooting the texture compound. These machines achieve an even texture easily.

Such machines are not practical for texturing a small area of the wall/ceiling in cases, for example, after repairing a hole/damage or after remodeling a small part of a room. However, leaving the repaired or remodeled part smooth is a permanent eye sore. Therefore it is important to texture the new part of the wall before painting it.

Aerosolized cans are commercially available for texturing of small areas of drywall. These cans are designed to spray a specific material in the form of slurry on the wall such that the material forms very small and thin bead-like deposits on the drywall surface. When the material dries completely these deposits form a texture. There are several problems with the aerosolized cans.
1. The slurry has to be thick enough to deliver enough material on the wall. On the other hand, a fine texture requires that the bead-like deposits are not too thick or too large. Therefore the nozzle through which the slurry is discharged must be narrow. Like any system for pushing thick material through a narrow passage, the cans are subject to very frequent clogging. Often the material left over from the previous application dries on the nozzle and completely blocks it, making any further use of the can impossible.
2. Whenever the can is left on the shelf for a few days the texture material settles at the bottom. This means the material must be re-dispersed into a slurry. This is always done manually by shaking the can. The condition of appropriate consistency of the slurry is very stringent, usually requiring vigorous shaking for at least a half hour.
3. Usually the instructions for using the can are rather vague. Descriptions like “select small or medium or large nozzle” do not give the user a good idea of what the outcome will be. The user is also asked to hold the can at a suitable distance and a suitable angle. Thus only an expert user is capable of achieving the desired texture. Even an expert user cannot reproduce a texture well enough to make the patterns in 2 different areas indistinguishable from each other. Thus the result is both unpredictable and irreproducible.
4. Because the can has to be held at a distance of more than several inches from the wall, it is impossible to limit the spray shape for confining it to the desired area. Therefore it is imperative to isolate the area by covering all surrounding areas with brown paper or other suitable materials. This is a fairly time consuming and tedious task. It can also be quite expensive. It is also next to impossible to cover perfectly. In practice most users will find stray texture materials on far off spots on the wall, floor and furniture.
5. The slurry requires long time to dry during which the wall cannot be painted. Even the “fast dry” brands take several hours.
6. The can is of limited size and will invariably run out after a certain area is textured.

2. Objects and Advantages

The object of Easy Texture is to provide a means to apply a texture on a small to medium-sized area of drywall very easily. It is free from all of the above-mentioned disadvantages that are associated with the aerosolized cans. Moreover, as described below Easy Texture offers several unique advantages compared to the aerosolized cans.

The current embodiment of the Easy texture has a mat with a textured surface. The pattern of the texture on the mat is exactly opposite of the desired texture. The mat is mounted on a rigid board with a handle. The user holds the Easy Texture by the handle and lightly presses the mat on the drywall that is freshly coated with a smooth layer of a joint compound. Because the joint compound on the wall is soft the mirror-image of the texture of the mat is formed on it. As the joint compound dries it faithfully retains the texture and the wall is ready to be painted.

Clearly, with Easy Texture there is little or no need for the user expertise for texturing the drywall. The pattern of the texture is completely determined by choosing the desired Easy Texture mat. There is no issue of choosing a distance or angle. The mat is simply put flatly on the flat wall with very light pressure. A properly sized mat will easily and quickly puts texture on fairly large areas to any small areas or rounded corners of the drywall.

The instructions for using Easy Texture are, in fact, completely stated in the paragraph above. Thus using Easy Texture is as easy as using a screw driver.

With Easy Texture the texture on the wall is the mirror image of that on the mat. Even though on a few square inch area of the wall the texture is irregular, over a large area it is far from random. In fact, the acceptable texture has a high degree of symmetry when viewed over an area of more than several square inches. This symmetry makes mirror images identical. In other words the texture on the wall is identical to the texture on the mat. Thus one gets what one sees which makes the result both predictable and reproducible.

There is no issue of clogging anything. The material of the mat can be chosen such that the joint compound does not stick to the mat. After using Easy Texture the mat can be wiped clean with moist cloth etc. and it is as good as new for using again. Or, it can be simply put aside and still can be used again with or without dusting off the surface of the mat.

Since most brands of joint compound are neither abrasive nor corrosive, the mat is not affected by use and can last almost forever. It can be used for texturing almost unlimited number of small areas of the wall.

There is no spluttering involved. Therefore there is no need for the time and labor for covering the surrounding areas. The Easy Texture has a defined edge. Thus with little care the user can limit the texturing process extremely precisely. This saves a significant amount of time and labor.

Texturing with Easy Texture saves time by another factor, namely, by eliminating one step to the final product. The user does need to wait for the joint compound to dry and then apply the texture. There is no need to wait further for the texture material to dry. With Easy Texture the latter step is eliminated. One uses the Easy Texture when the joint compound is still wet and soft and the wall is ready to be painted as soon as the joint compound dries.

Further objects and advantages of my invention will become apparent from a consideration of the drawings and ensuing description.

### SUMMARY

The Easy Texture contains a mat made of appropriate material. The surface of the mat is uneven. Its dimension is suitable for quickly transferring the unevenness onto drywall surface that is freshly coated with soft joint compound. Thus Easy texture is very useful for quickly texturing small to medium-sized areas of walls in a predictable and reproducible manner.

### DRAWINGS

FIG. 1: illustrates a prototypical embodiment of this invention (front view)

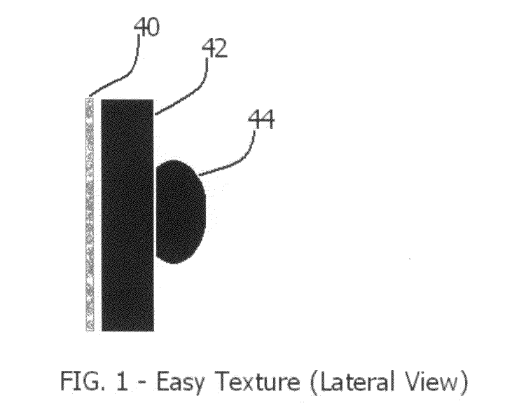

FIG. 2: illustrates the lateral view of the prototypical embodiment of this invention

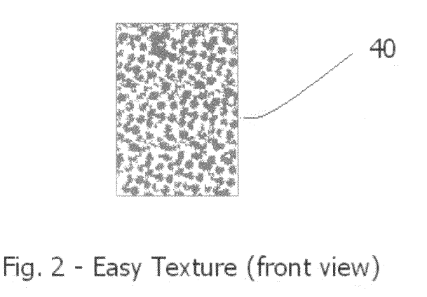

FIG. 3: illustrates placing of the Easy Texture on drywall that has been prepared for texturing

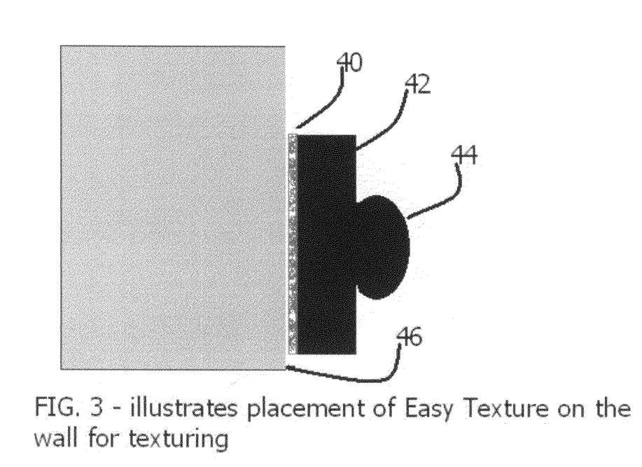

### REFERENCE NUMERALS

40 Mat of appropriate material and with carefully-designed uneven surface
42 Rigid support for the mat 40
44 Handle for holding the mat 40 on its rigid support 42
46 Drywall freshly coated with joint compound on which Mat 40 is pressed lightly for transferring the texture

### OPERATION

Texturing of drywall with Easy Texture is virtually a single step process. However, depending on the conditions of the wall, it may sometimes need 2 prior steps (Steps 1 and 2) for preparation of the wall and then completing the job in Step 3 as described below:

Step 1: The drywall should be repaired properly. It is best to use pieces of intact drywall to replace all damages except cracks. The new drywall piece should be attached on the stud or on retro-stud as convenient.

Step 2: Apply the appropriate joint compound to fill-up all cracks. Deep or very wide cracks may need multiple coatings and may need excess compound to be removed by sanding after it is dry. With small or narrow cracks the fillings can be sufficiently smoothed when wet after the first coating. Use a flat trowel so that the new drywall, all nail or screw heads and a small portion of original drywall around the new piece is completely covered.

Step 3: Lightly press the Easy Texture on all areas containing the joint compound. Avoid repeated pressing on the same spot or excessive overlapping.

### CONCLUSION, RAMIFICATIONS AND SCOPE

The Easy Texture imprints a texture on the drywall easily and quickly. In general, the popular patterns of texture do not vary widely. However, with Easy Texture many different intricate patterns can be easily obtained if desired.

Although the descriptions above contain some specifications, these should not be construed as limiting the scope of the invention, but merely as providing illustrations of some of the presently preferred embodiments of this invention. For example, the material for the mat, its dimensions, its rigid support and the handle afford room for variations which may improve the quality and ease of texturing on drywall.

Thus the scope of the invention should be determined by the appended claims and their legal equivalents, rather than by the examples given above.

I claim:

1. A method of easily imprinting a texture on drywall, comprising the steps of:
(a) coating said drywall with a thin layer of a suitable paste,
(b) insuring that said coating is smooth,
(c) also insuring that said coating has not significantly hardened,
(d) lightly pressing a textured surface of specified materials having specified dimensions on said drywall,
whereby, said texture is imprinted on the soft material of said paste which subsequently hardens retaining the form and thus rendering the surface of said drywall textured.

2. An article of home improvement that is capable of imprinting a texture on drywall, comprising of
(a) a surface of suitable material,
(b) said surface having suitable dimensions,
(c) with a texture of suitable design permanently or semi-permanently imprinted on said surface,
(d) said material having means of being placed on drywall surface properly prepared for texturing,
whereby a texture corresponding to said texture on said surface of said material becomes imprinted on said drywall surface.

3. An Article of claim 2 where said material is pliable and is attached to a rigid support.

4. An Article of claim 2 where said material is rigid.

5. An article of claim 2 where the said texture has a specific design.
